(19) United States
(12) Patent Application Publication
(10) Pub. No.: US 2023/0175922 A1
(43) Pub. Date: Jun. 8, 2023

(54) Systems for Mechanical Static and Dynamic Characterization of Structures and Adjustment of Radio Frequency Aperture and Transmission

(71) Applicant: Redwire Holdings, LLC, Jacksonville, FL (US)

(72) Inventors: Dave Crotser, Longmont, CO (US); Heather Passe, Boulder, CO (US); Lee Peterson, Placitas, NM (US)

(21) Appl. No.: 17/981,417

(22) Filed: Nov. 5, 2022

Related U.S. Application Data
(60) Provisional application No. 63/285,334, filed on Dec. 2, 2021.

(51) Int. Cl. G01M 11/00; G01S 17/89; G01S 7/48; G01B 11/16

(52) U.S. Cl. CPC G01M 11/3172; G01S 17/89; G01S 7/4808; G01B 11/16

(57) ABSTRACT

The present disclosure provides for systems and methods for quasi-static and dynamic characterization and adjustment of radio frequency aperture and transmission. The system may comprise a transmission structure with a plurality of sensors. The system may comprise a plurality of optical metric markers. The system may receive corrective signals, shape, or deflection knowledge, or any combination thereof, from an estimator to one or more controllers. The method may comprise association of distance measurements received from a plurality of sensors through physical system identification to plot cartesian coordinates in three-dimensional space as a function of time. When the system comprises one or more controllers, the controllers may be actuated in response to shape or deformation knowledge provided by the computation module. The estimator may comprise phase correction of a large array from sparse data that is then translated to controller actuation.

### CROSS-REFERENCE TO RELATED APPLICATION

This application is a Non-provisional of and claims priority to U.S. Provisional Patent Application Ser. No. 63/285,334 (filed Dec. 2, 2021, and titled “SYSTEMS FOR MECHANICAL STATIC AND DYNAMIC CHARACTERIZATION OF STRUCTURES AND ADJUSTMENT OF RADIO FREQUENCY APERTURE AND TRANSMISSION”), the entire contents of which are incorporated herein by reference.

This invention was made with government support under (Contract No. FA9453-20-C-0003) awarded by Air Force Research Laboratory (AFRL). The government has certain rights in the invention.

### BACKGROUND

Systems of measurement enable humanity to make sense of the data they collect. Systems of measurement also facilitate the categorization of data. There are several ways to measure temperature, weight, length, volume, force, speed, time, and more. All of these systems require particular instruments that are calibrated to adequately measure the relevant data. Most of these instruments are highly sophisticated; others are constantly being iterated in the hopes of furthering innovation in their relative fields, such as measuring moving objects in space.

Uncrewed satellites in Earth's orbit perform various functions including collecting data, relaying communications, and providing navigation knowledge and services. Distance, lack of gravity, light distortion, orbits, and other extraterrestrial challenges make measuring celestial bodies, particularly moving ones, and characterizing surfaces incredibly difficult. Current methods revolve primarily around the use of satellite telescopes having optic components. These optic components, typically high-tech cameras, capture a series of images of single targets that are later measured using printed or digitized photographs.

Existing and developing orbital technologies benefit from knowledge of shapes, positions, and/or deflections of structures and objects within the system. For example, large radio frequency (RF) apertures can be electronically phase-corrected if the aperture shape is known; large deployable systems can be characterized if the motions and final position of elements are monitored; on orbit assembly, docking, and rendezvous operations can be enabled by monitoring motions and positions of system elements.

While there are software systems that make this process easier, there is not currently anything available that enables real-time measurement of a moving object or the characterization of shape deformation, or swarm of objects, through space using optic metric markers. Additionally, using these forms of metrology to is unable to measure more than a single point from a single sensor at a time. To accurately characterize a surface after the space object is in orbit, a more comprehensive dataset is required.

Knowing the final or continually changing aperture shape or deformation on an object in space is the only path to correction of existing deformations. Correcting these deformations may be critical in scenarios where the object in space is responsible for transmission, as an example.

### SUMMARY OF THE DISCLOSURE

What is needed are systems for dynamic characterization and adjustment of radio frequency structures through aperture and transmission structure modification. In some embodiments, the systems or methods may comprise an optical metrology device for real-time shape characterization of aperture deformation for phase correction of antenna array. This device implements an Optical Frequency Domain Reflectometry (OFDR) free-space range measurement instrument, multilateration for displacement characterization, and numerical estimation for high-fidelity static and dynamic structure characterizations.

The presently described laser range-finding technology can be configured to simultaneously measure a plurality of optical metric markers. The computation module may be able to use this information to calculate size, shape, and even velocity of an object of interest at near real-time refresh rates. In some embodiments, the optical metrology system may measure large aperture RF arrays to enable electronic phase correction. In some implementations, the optical metrology system may be easily configurable to serve on-orbit operations such as docking, rendezvous, and other proximal operations.

The present disclosure comprises a form of laser distance measurement using optical phase comparison ideal for high-resolution strain measurements. This technology, when not coupled to a fiber optic, may be used for long-distance, high-accuracy, free-space range measurements, ideal for a non-contact metrology system. Traditional laser range finders measure range to one optical metric marker at a time, where OFDR free space offers the ability to measure ranges and range velocities to multiple optical metric markers simultaneously.

The present disclosure provides for systems for static and dynamic characterization and adjustment of radio frequency aperture and transmission. The system may comprise a transmission structure, a plurality of sensors, and a plurality of optical metric markers. The optical metrology system may use the shape, size, coating, or other non-limiting physical attribute, of an optical metric marker to associate an optical metric marker with a range or received metric. In some embodiments, the shape, size, or coating of a target may be adjusted to make a uniquely-shaped return peak in the range data output.

Sensor measurements may be processed by a decipherer to correlate the metric measurements with the associated sensors and optical metric markers. These correlations may be referred to as ‘metadata’. The multilateration module may use the correlated ranges to calculate the cartesian coordinates of all sensors and optical metric markers.

The estimator may use the output of the multilateration, or trilateration, or both, to calculate the structural shape or deformation at a higher spatial density than the spatial density of optical metric markers. In some aspects, the output of the estimator may be used for phase correction of RF arrays.

### BRIEF DESCRIPTION OF THE DRAWINGS

The accompanying drawings that are incorporated in and constitute a part of this specification illustrate several embodiments of the disclosure and, together with the description, serve to explain the principles of the disclosure:

FIG. 1A illustrates an exemplary optical metric marker of an optical metrology system, according to some embodiments of the present disclosure.

FIG. 1B illustrates an exemplary optical metric marker of an optical metrology system, according to some embodiments of the present disclosure.

FIG. 2 illustrates an exemplary optical metrology system, according to some embodiments of the present disclosure.

FIG. 3 illustrates an exemplary optical metrology system, according to some embodiments of the present disclosure.

FIG. 4 illustrates an exemplary method of a computation module, according to some to embodiments of the present disclosure.

### DETAILED DESCRIPTION

In the following sections, detailed descriptions of examples and methods of the disclosure will be given. The description of both preferred and alternative examples, though thorough, are exemplary only, and it is understood to those skilled in the art that variations, modifications, and alterations may be apparent. It is therefore to be understood that the examples do not limit the broadness of the aspects of the underlying disclosure as defined by the claims.

### Glossary

Computation module: As used herein refers to a portion of the optical metrology system that interacts with the data collected from the optical metrology system. In some embodiments, the computation module may comprise a decipherer that associates each range or metric received with an associated sensor and optical metric marker. In some implementations, the computation module may comprise a chirplet pre-processor. In some aspects, the computation module may comprise a multilateration module that receives range data and calculates three cartesian coordinates for each optical metric marker and each sensor. In some implementations, the computation module may comprise OFDR instrumentation that outputs an intensity peak at a range from the exit port of the instrument. In some embodiments, the computation module may comprise an estimator that may map cartesian coordinates of optical metric markers to nodes of a finite element model and calculate resulting positions and orientations of RF elements, or other locations or elements of interest.

Sensor: As used herein refers to a receiver of optical input. In some embodiments, the sensor may comprise a sensor-head. In some implementations, the sensor-head may transmit the intended signal, to be returned by a retroreflective optical metric marker. In some aspects, the sensor may transmit signal to and receive returned signal from a plurality of optical metric markers simultaneously.

Controller: As used herein refers to a mechanism that performs an adjustment in response to input from the optical metrology system. In some embodiments, the controller may comprise a mechanical actuator, a software executable, or both, as non-limiting options. In some implementations, the object acted upon may enact anticipated corrections and adjustments from the optical metrology system. For example, a controller may mechanically actuate a transmission panel based on feedback from the optical metrology system that may improve the transmission in real-time.

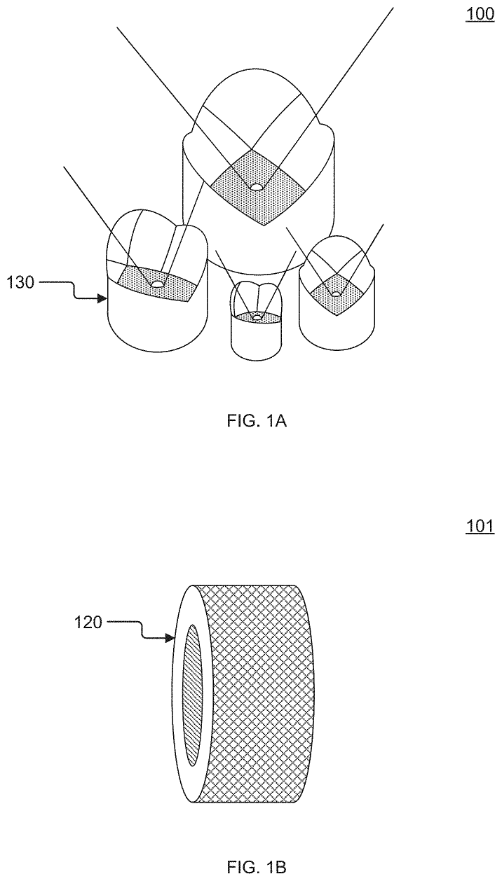

Referring now to FIGS. 1A-B, a sensor 130 and optical metric marker 120 of an optical metrology system 100 is illustrated. In some embodiments, the OFDR instrument may output an intensity peak at a range. In some implementations, the intensity peak may not contain metadata about which sensor 130 and optical metric marker 120 the range is associated with. In some aspects, the shape, size, coating, or other non-limiting physical attribute, of an optical metric marker 120 may associate an optical metric marker 120 with a range.

In some embodiments, the shape, size, or coating of an optical metric marker may be adjusted to make a uniquely-shaped return peak in the range data output. In some implementations, the physical identifiers of the optical metric markers may allow the optical metrology system to identify necessary adjustments to RF transmission quickly and actuate transmission panels accordingly.

In some embodiments, the optical design of the sensor 130 may shape the emitted signal to be a circular or elliptical cone, or any other shape, in free space. In some aspects, the sensor 130 may comprise a collimator, lenses, a fiber optic connector, or some combination thereof. In some implementations, the shape of the emitted signal may be designed to optimize and limit field of view to the optical metric markers while minimizing signal loss.

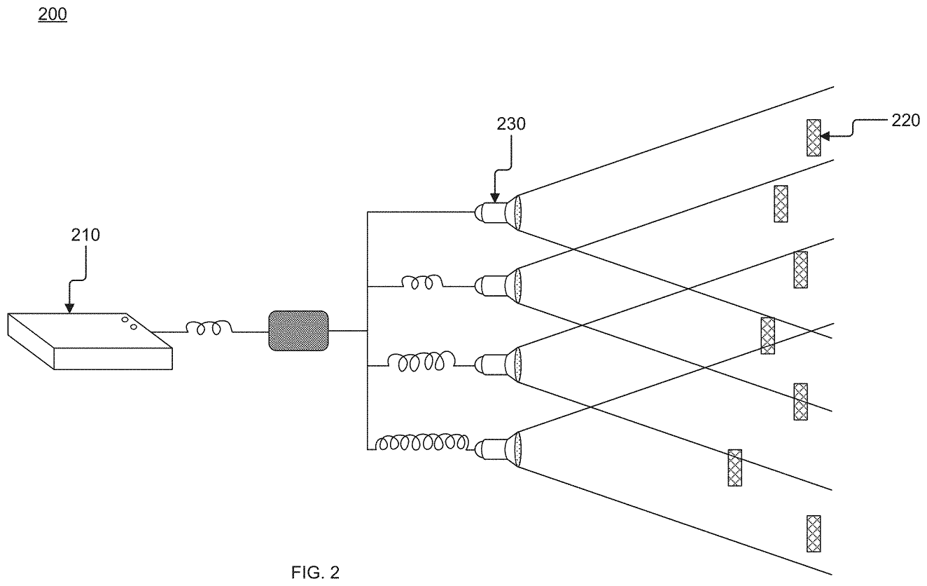

Referring now to FIG. 2, an optical metrology system 200 is illustrated. In some implementations, the optical metrology system 200 may comprise a plurality of sensors 230. In some aspects, the sensors 230 may send optical signals to a plurality of optical metric markers 220. In some embodiments, the optical metrology system 200 may comprise a computation module 210 that associates received metric information with corresponding sensors 230 and optical metric markers 220. In some implementations, the optical metrology system 200 may incorporate physical signal delays into the sensors 230 to differentiate information received from different sensors 230.

In some aspects, the signal delays may be affected by fiber optics of predetermined lengths between a fiber optic beam splitter and position sensors 230 to form a unique and identifiable range bias on all measurements from each sensor 230. In some embodiments, this bias may separate signals in range space and increase the separation of sets of intensity peaks from each sensor 230 when data from four sensors is recombined by the computation module 210. These separate signals may increase refresh-rates for real-time transmission adjustment by eliminating the need for additional associative calculations.

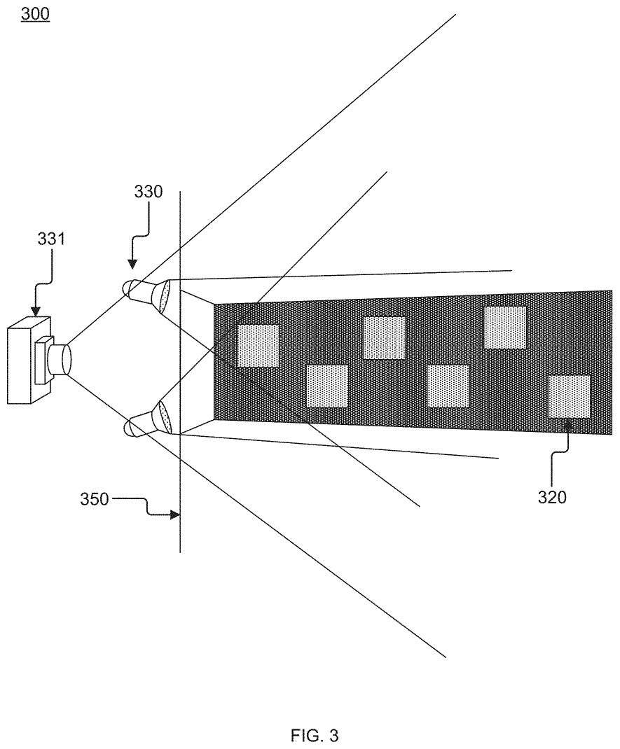

Referring now to FIG. 3, an optical metrology system 300 is illustrated. In some embodiments, the optical metrology system 300 may comprise a transmission structure 350. In some implementations, the optical adjustment system 300 may comprise a plurality of sensors 330. In some aspects, the sensors 330 may send optical signals to a plurality of optical metric markers 320.

In some implementations, the transmission structure 350 may comprise a plurality of surfaces. In some aspects, the optical metrology system 300 may engage sensors 330 to characterize the surfaces of the transmission structure 350. In some aspects, the sensors 330 may collect linear metrics or a range, or both, received from a plurality of optical metric markers 320.

In some embodiments, the optical metrology system 300 may comprise two or more types of sensors 331. In some implementations, non-OFDR sensor 331 data may be coupled with OFDR distance measurements to generate a hybrid metrology system that leverages the measurement strengths of the incorporated technologies. In some aspects, the sensors 330, 331 may provide data to a computation module that may determine displacements, velocities, and other non-limiting metrics in three dimensions. For example, by combining a two-angle-measurement camera with OFDR, the optical metrology system may use only one camera and fewer than four OFDR sensors 330 to plot the full set of cartesian position data for each optical metric marker 320.

In some aspects, a RF controller may utilize the computed matrix of element displacements and rotations to command the phase and power of the transmission elements to emulate the desired radio frequency pattern. In some embodiments, the resulting radio frequency pattern may be transmitted. In some implementations, the radio frequency pattern error may comprise the absolute value of the difference between the desired radio frequency pattern and the transmitted radio frequency pattern. In some aspects, the implementation of a plurality of sensor 330, 331 types may increase refresh-rates for real-time RF transmission adjustment by eliminating the need for additional calculations.

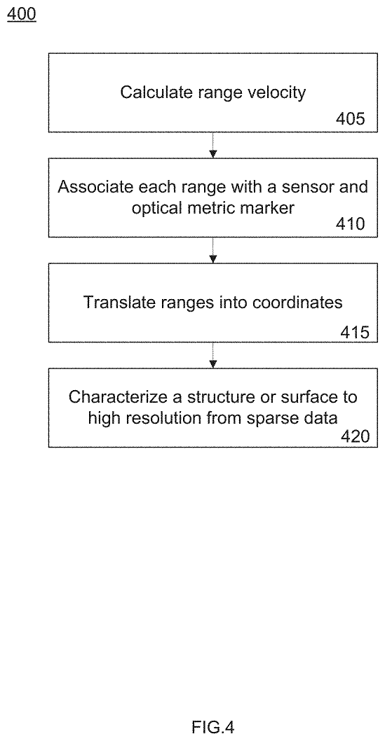

Referring now to FIG. 4, an exemplary method for an exemplary computation module 400 is illustrated. In some embodiments, the computation module 400 may comprise a chirplet pre-processing module. In some aspects, the computation module 400 may comprise a deciphering module. In some embodiments, the computation module 400 may comprise a multilateration module. In some implementations, the computation module 400 may comprise an estimator.

At 405, the chirplet pre-processing module may calculate range velocity and corrected range when motion is present. In some aspects, the chirplet pre-processor may receive either raw OFDR time data or raw OFDR frequency data, which may comprise a Fourier transform of the time data. In some embodiments, the chirplet pre-processor may produce a range rate and a corrected range. In some implementations, the chirplet pre-processor may allow the optical metrology system to function accurately despite structural vibrations. In some embodiments, the chirplet pre-processor may transmit the range rate and the range for each optical metric marker to the deciphering module.

At 410, the deciphering module may associate each range with a sensor and optical metric marker. In some implementations, the deciphering module may associate each range or distance received with a specific optical metric marker and corresponding sensor. In some aspects, the deciphering module may be utilized for initial test cases: a limited number of targets that may comprise a limit on minimum target spacing. In some embodiments, the deciphering module may receive range and intensity data from the sensors and output sets of ranges associated with sensors and optical metric markers. For example, when using light as a method of measurement, the deciphering module may determine which sensor emitted and received the measured light and which retroreflective optical metric marker returned the light to the sensor.

At 415, the multilateration module may translate ranges into coordinates. In some implementations, the multilateration module may receive range and range rate sets with the sensor and optical metric marker metadata from the deciphering module and output (x,y,z) coordinates of correlated sensors and optical metric markers. In some aspects, the multilateration module may produce cartesian velocities of the optical metric markers.

In some embodiments, the computation module may complete reference target separation in the spatial domain, or in the temporal domain, or both for on-orbit calibration and additional multilateration bounding. In some implementations, this design may use invariants in the system to provide additional bounding constraints on the estimator to reduce errors. For example, pre-determined and mechanically stable relative optical metric marker positions from a single measurement, and across multiple measurements across time, may provide known and physically meaningful constraints to the estimator solution space.

At 420, the estimator may characterize a structure or surface to high resolution from sparse data. In some implementations, the estimator may receive coordinates and velocities of optical metric markers and transmit positions and angles of RF elements. In some aspects, the estimator may transmit positions and angles of other objects of interest that are marked with optical metric markers. In some embodiments, the positions and angles of RF elements may be transmitted to the controllers, which may actuate the RF transmitters, or otherwise correct the transmitting RF beam by adjusting the phase and power at various elements, as non-limiting examples.

### CONCLUSION

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combination or in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single product or packaged into multiple products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A system for optical metrology, the system comprising:
one or more sensors communicatively coupled with one or more optical metric markers;
a computation module communicatively coupled with the one or more sensors, wherein the computation module is configured to receive data from the one or more sensors and one or more optical metric markers; and
a transmission structure with one or more surfaces, wherein the one or more optical metric markers are located on the one or more surfaces.

2. The system for optical metrology of claim 1, wherein one or more a shape, a size, or a coating of the one or more optical metric markers define a range.

3. The system for optical metrology of claim 1, wherein at least one optical design of an emitted signal from the one or more sensors comprises a circular or elliptical cone.

4. The system for optical metrology of claim 1, wherein the transmission structure comprises a space object.

5. The system for optical metrology of claim 1, further comprising a chirplet pre-processing module communicatively coupled with the computation module, wherein the chirplet pre-processing module is configured to calculate a range velocity and a corrected range.

6. The system for optical metrology of claim 5, wherein the chirplet pre-processing module is further communicatively coupled with the one or more sensors, and wherein the chirplet pre-processing module calculates the range velocity and the corrected range when the one or more sensors detect motion.

7. The system for optical metrology of claim 6, wherein the chirplet pre-processor receives one or both raw OFDR time data or raw OFDR frequency data from the computation module.

8. The system for optical metrology of claim 7, wherein one or both raw ODFR time data or raw OFDR frequency data comprise a Fourier transform of the time data.

9. The system for optical metrology of claim 6, the chirplet pre-processor limits risk of inaccuracies due to structural vibrations.

10. The system for optical metrology of claim 1, further comprising a decipher module communicatively coupled with the computation module, wherein the decipher module is configured to associate a range with one or more sensors and one or more optical metric markers.

11. The system for optical metrology of claim 10, further comprising a multilateration module communicatively coupled with the computation module, wherein the multilateration module is configured to translate a range into a coordinate.

12. The system for optical metrology of claim 11, wherein the multilateration module periodically receives a range and a first range rate set with sensor and optical metric marker metadata from the deciphering module and output coordinates of correlated sensors and optical metric markers.

13. The system for optical metrology of claim 1, further comprising an estimator communicatively coupled with the computation module, wherein the estimator is configured to characterize a structure from information from the computation module.

14. The system for optical metrology of claim 1, wherein one or more physical attributes of the one or more optical metric markers are adjustable.

15. The system for optical metrology of claim 14, wherein changing the one or more physical attributes increases an ability of the system to identify adjustments in RF transmission.

16. The system for optical metrology of claim 1, wherein the one or more sensors comprise one or more of a collimator, a lens, or a fiber optic connector.

17. The system for optical metrology of claim 1, wherein the one or more sensors periodically transmits one or more optical signals to the one or more optical metric markers.

18. The system for optical metrology of claim 17, wherein the one or more optical signals transmit a delayed intervals, wherein the delayed intervals differentiate information received by the one or more sensors.

19. The system for optical metrology of claim 18, further comprising fiber optics of predetermined lengths between a fiber optic beam splitter and position sensors, wherein the predetermined lengths at partially define a signal delay

20. The system for optical metrology of claim 19, wherein the one or more signal delays form a unique and identifiable range based at least partially on measurements from each of the one or more sensors.
